(19) United States
(12) Patent Application Publication
(10) Pub. No.: US 2021/0158416 A1
(43) Pub. Date: May 27, 2021

(54) SYSTEMS AND METHODS FOR CREATING, SHARING, REACTING TO, AND BUYING A LOOK IN A PLATFORM COMPRISING CUSTOMER DATA, PRODUCT DATA, AND LOOK DATA

(71) Applicant: SHOPCRE8, INC., San Francisco, CA (US)

(72) Inventors: Michael HUBBARD, Grapevine, TX (US); James MEEKS, Mansfield, TX (US)

(21) Appl. No.: 17/105,325

(22) Filed: Nov. 25, 2020

Related U.S. Application Data
(60) Provisional application No. 62/941,594, filed on Nov. 27, 2019.
(60) Provisional application No. 62/941,596, filed on Nov. 27, 2019.
(60) Provisional application No. 62/941,598, filed on Nov. 27, 2019.

(51) Int. Cl. G06Q 30/06; G06Q 50/00; G06T 11/60

(52) U.S. Cl. CPC G06Q 30/0621; G06Q 50/01; G06T 2200/24; G06Q 30/0633; G06T 11/60; G06Q 30/0643

(57) ABSTRACT

A system comprising: a plurality of user devices comprising an application or web browser; one or more databases configured to store customer data, product data, and look data; an orchestration server coupled with the one or more databases and the user devices, coupled with the one or more databases and the user devices, and comprising at least one hardware processor; and one or more software modules that are configured to, when executed by the at least one hardware processor: present a marketplace comprising items associated with the product information and to allow a user of one of the plurality of user devices to create a look using the application or browser by: selecting one or multiple products from the marketplace to form a look; edit the look by adding or deleting products; sharing the look with other users of the plurality of user devices; receive quick reactions to the shared look from the other users; and edit the look again based on the quick reactions.

### CROSS-REFERENCE TO RELATED APPLICATIONS

This application claims priority to U.S. Provisional Application No. 62/941,594, filed Nov. 27, 2019, U.S. Provisional Application No. 62/941,596, filed Nov. 27, 2019 and U.S. Provisional Application No. 62/941,598, filed on Nov. 27, 2019, the contents of which are incorporated herein by reference.

### BACKGROUND

### 1. Technical Field

The embodiments described herein are related to a platform that allows customers the unique ability to create looks in an electronic marketplace, share these looks with friends to get feedback and receive suggestions from their friends on how to improve the looks. When the customers (or their friends) like any of the looks, they're able to purchase the entire look, or a subset of items in the look, quickly and easily.

### 2. Related Art

Many electronic commerce (e-commerce) websites and mobile apps offer shopping experiences where users can browse products from an e-commerce catalog, and some even offer a “shop the look” experience where the e-commerce websites and mobile apps show additional products from different categories that complete the look (i.e. tops, bottoms, and shoes). Some e-commerce websites and mobile apps even offer a “social commerce” experience, where influencers post lifestyle images with multiple products, and users can ‘like’ the product and/or influencer. The e-commerce websites and mobile apps make these liked products shoppable by linking to the affiliate retailer's product page, causing a disjointed customer experience.

### SUMMARY

Systems and methods for allowing a user to browse products from an e-commerce catalog, or a user's virtual closet, where users can select one or multiple products, then configure the group of products into a look are described herein. Configured looks can be shared with a community of friends, influencers, and other system users. Configured looks can be modified by any user who's created or received a configured look. Users are able to purchase any look that they have created, as well as purchase looks shared or received from other users. Users are able to receive AI generated recommendations based on any look that a user has created, shared or purchased.

According to one aspect, a system comprising: a plurality of user devices comprising an application or web browser; one or more databases configured to store customer data, product data, and look data; an orchestration server coupled with the one or more databases and the user devices, the orchestration server configured to present a marketplace comprising items associated with the product information and to allow a user of one of the plurality of user devices to create a look using the application or browser by: selecting one or multiple products from the marketplace to form a look; edit the look that they have created by adding or deleting products; sharing the look with other users; and the other users quick reacting to the shared look.

These and other features, aspects, and embodiments are described below in the section entitled “Detailed Description.”

### BRIEF DESCRIPTION OF THE DRAWINGS

Features, aspects, and embodiments are described in conjunction with the attached drawings, in which:

FIG. 1 is a diagram illustrating an example system architecture in accordance with one embodiment;

FIG. 2 is a diagram illustrating a looks solution implemented on the architecture of FIG. 1;

FIG. 3 is a diagram illustrating a user flow of creating and buying a looks implemented on the architecture of FIG. 1;

FIG. 4 is a diagram illustrating an example process for implementing a user flow for creating and buying a look on the architecture of FIG. 1;

FIG. 5 is a diagram illustrating an example process for implementing a user flow of sharing, reacting, and buying a look on the architecture of FIG. 1; and

FIG. 6 a block diagram illustrating an example wired or wireless system that can be used in connection with various embodiments described herein.

FIG. 7 is a block diagram illustrating an example wired or wireless system that can be used in connection with various embodiments described herein.

### DETAILED DESCRIPTION

The disclosure and the various features and advantageous details thereof are explained more fully with reference to the non-limiting embodiments and examples that are described and/or illustrated in the accompanying drawings and detailed in the following. It should be noted that the features illustrated in the drawings are not necessarily drawn to scale, and features of one embodiment can be employed with other embodiments as the skilled artisan would recognize, even if not explicitly stated herein. Descriptions of well-known components and processing techniques can be omitted so as to not unnecessarily obscure the embodiments of the disclosure. The examples used herein are intended merely to facilitate an understanding of ways in which the disclosure can be practiced and to further enable those of skill in the art to practice the embodiments of the disclosure. Accordingly, the examples and embodiments herein should not be construed as limiting the scope of the disclosure. Moreover, it is noted that like reference numerals represent similar parts throughout the several views of the drawings.

Embodiments of processes for allowing a user to browse products from an e-commerce catalog, or a user's virtual closet, where users can select one or multiple products, then configure the group of products into a look will now be described in detail. It should be understood that the described processes may be embodied in one or more software modules that are executed by one or more hardware processors (e.g., processor 560), for example, as the application discussed herein (e.g., server application 112, client application 132, and/or a distributed application comprising both server application 112 and client application 132), which may be executed wholly by processor(s) of platform 110, wholly by processor(s) of user system(s) 130, or may be distributed across platform 110 and user system(s) 130, such that some portions or modules of the application are executed by platform 110 and other portions or modules of the application are executed by user system(s) 130. The described processes may be implemented as instructions represented in source code, object code, and/or machine code. These instructions may be executed directly by hardware processor(s) 210, or alternatively, may be executed by a virtual machine operating between the object code and hardware processors 210. In addition, the disclosed application may be built upon or interfaced with one or more existing systems.

Alternatively, the described processes may be implemented as a hardware component (e.g., general-purpose processor, integrated circuit (IC), application-specific integrated circuit (ASIC), digital signal processor (DSP), field-programmable gate array (FPGA) or other programmable logic device, discrete gate or transistor logic, etc.), combination of hardware components, or combination of hardware and software components. To clearly illustrate the interchangeability of hardware and software, various illustrative components, blocks, modules, circuits, and steps are described herein generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a component, block, module, circuit, or step is for ease of description. Specific functions or steps can be moved from one component, block, module, circuit, or step to another without departing from the invention.

Furthermore, while the processes, described herein, are illustrated with a certain arrangement and ordering of subprocesses, each process may be implemented with fewer, more, or different subprocesses and a different arrangement and/or ordering of subprocesses. In addition, it should be understood that any subprocess, which does not depend on the completion of another subprocess, may be executed before, after, or in parallel with that other independent subprocess, even if the subprocesses are described or illustrated in a particular order.

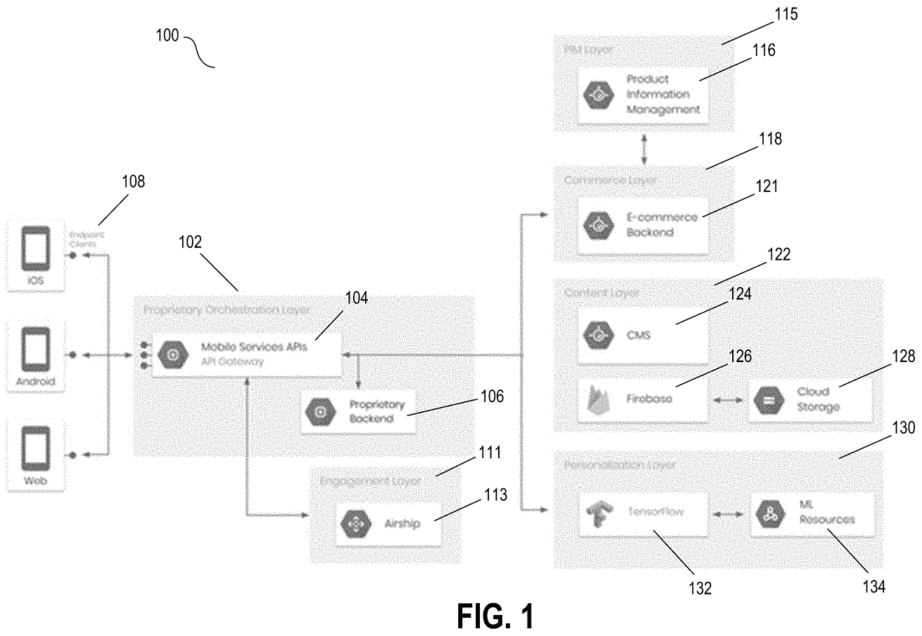

FIG. 1 is a diagram illustrating and example system architecture 100 in accordance with one example embodiment. As can be seen, system 100 comprises an orchestration layer 102 comprising mobile APIs 104 allowing applications running on user devices 108 to interface with the orchestration layer 102 including a backend 106. User devices 108 can be a mobile device such as a smartphone or tablet, as well as a computer such as a desktop or laptop computer, or any other device that run applications and can perform the functions described herein.

To that end, user devices 108 comprise an application that can be downloaded and configured to implement the functionality described herein. Alternatively, in certain implementation or embodiments, the functions described herein can be implemented through a browser.

A customer engagement layer 111 comprising a customer engagement engine 113 is also interfaced with the orchestration layer 102 via the APIs 104. Customer engagement engine 113 can be configured to develop and manage multi-channel customer engagement programs designed to cause user of user devices 108 to engage with system 100 and perform the functions described herein.

An e-commerce layer 118 with ecommerce engine 121 can also be interfaced with the orchestration layer 102 via API's 104. E-commerce layer provides ecommerce capability to system 100. Product Information Management (PIM) layer 115 with PIM engine 116 can then be interfaced with e-commerce layer 118 either directly or through orchestration layer 102. PIM layer 115 provides the product pricing and other information to enable the e-commerce functionality.

System 100 can also comprise a content layer 122 comprising, e.g., CMS system 124, as well as an app development engine 126, which can be interfaced with cloud storage 128.

System 100 can also comprise a personalization layer 130 comprising a machine learning engine 132, as well as machine learning resources 134.

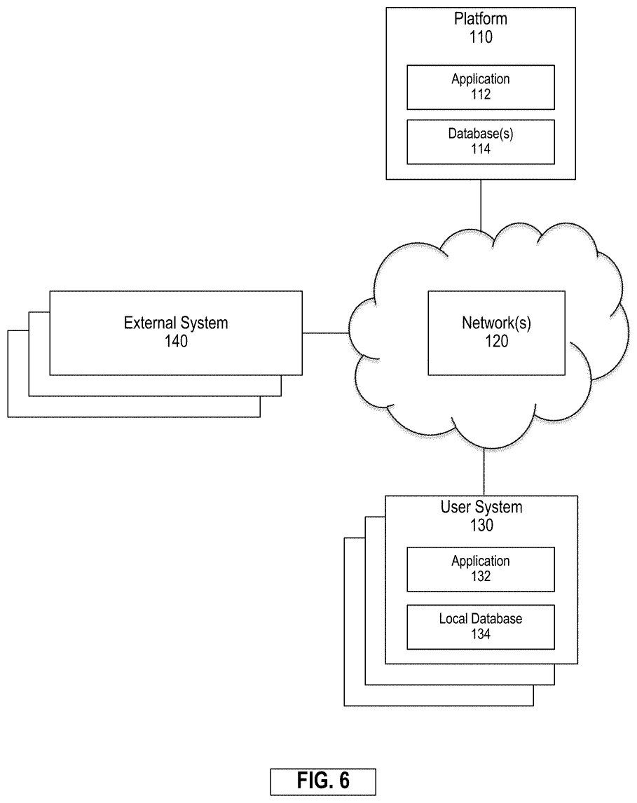

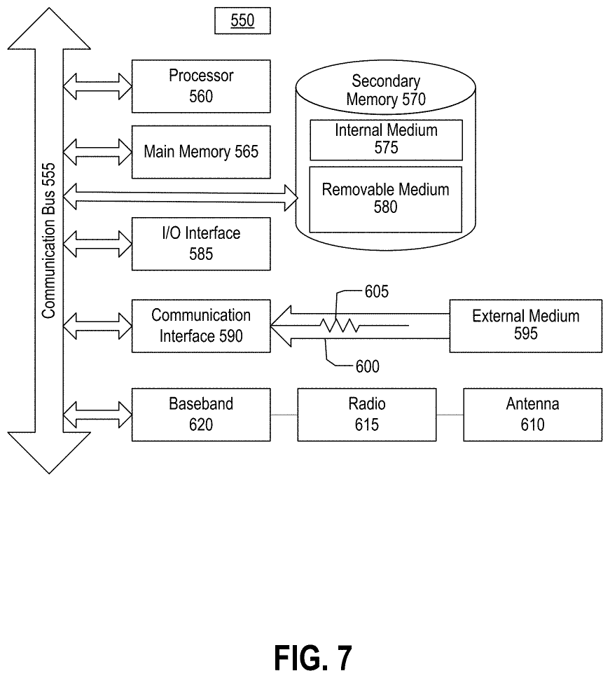

The term engine is intended to refer the resources, both hardware and software needed to carry out the intended functions and capabilities of the various components of system 100 some of which are described with respect to FIGS. 6 and 7.

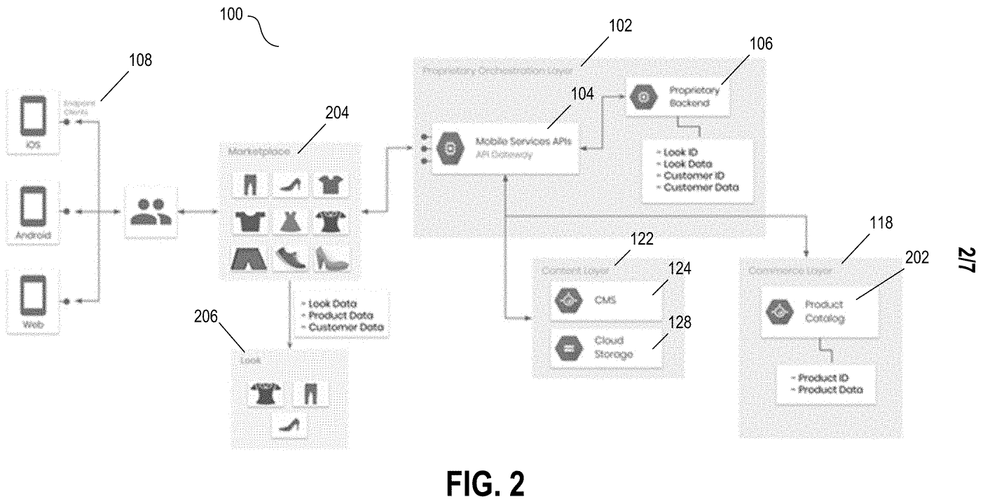

FIG. 2 is a diagram illustrating the curation and of looks 206 within system 100. As can be seen, commerce layer 118 can include a product catalog engine 202 in addition or as part of ecommerce engine 121, which can be configured to take product information, e.g., from PIM engine 116, in order to generate catalogs that include product information and product identification (ID).

Backend 106 can be configured to store look identification (ID) and look data as well as customer identification (ID) and customer data. The product ID and product information for various products from various retailers can then be presented in marketplace 204. Users of user devices 108 can then make product selections to create a look 206. When the user selects products for a look 206 the customer data identifying the user can be associated with the product as can look data identifying a specific look.

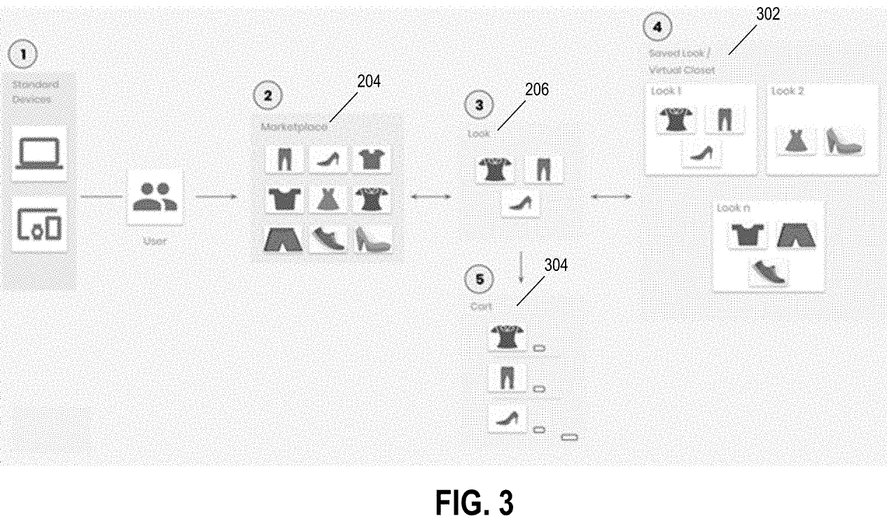

FIG. 3 is a diagram illustrating a user flow of creating and buying looks 206 implemented on the architecture 100 of FIG. 1. First, a user views marketplace 204 content via a web browser or mobile application. Marketplace 204 content is generated by a retailer(s), with user generated content created by influencers, designers, and shoppers (users). Next, the user creates a look 206 by selecting one or multiple products from the marketplace 204. The user can then share the look they created with other users, either via the mobile application or web browser.

User can edit/modify any look that they have created or that has be shared or received by the user. User can save looks (look 1, look 2, . . . , look n) and view previously created looks (look 1, look 2, . . . , look n) in their profile or virtual closet 302, where the user can select a look to modify, share or purchase the look. While any user is viewing any look, whether the look was posted to the marketplace 204 for all users to see, or if the look was shared by another user, they are able to add the entire look to their shopping cart 304, and buy the look quickly and easily.

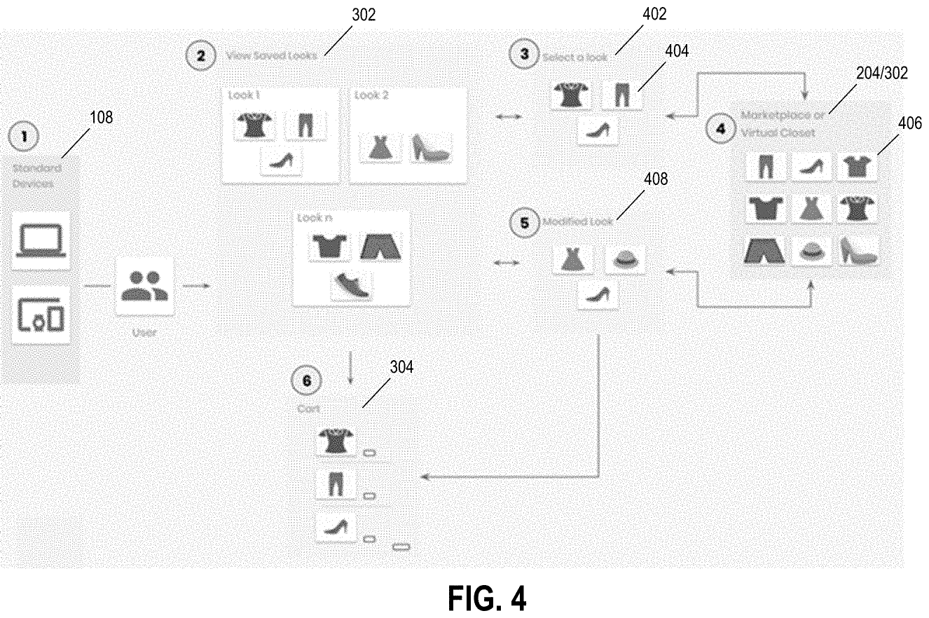

FIG. 4 is a diagram illustrating an example process for implementing a user flow for creating and buying a look on the architecture 100 of FIG. 1. First, the user views marketplace 204 content via web browser or mobile application. Marketplace 204 content is generated by the retailer, with user generated content created by influencers, designers, and shoppers (users). Users can navigate to view saved looks 302, looks 206 that have been shared with the user by others in the marketplace (other users, influencers, etc.). The user can then select a look 402 that they want to modify/change. The user can then change an existing item 404 for a new item 406, or is able to add new and remove existing items 406 from the marketplace 204 or those stored in virtual closet 302.

Thus, a user can browse the marketplace 204 or their virtual closet 302 to find a product 406 to add to an existing look 402. When user finds the item 406 they like, they can select it to be added to the existing look 402. The user can then view the modified/updated a look 408 and save it to their profile or virtual closet 302, or share it.

While any user is viewing any look (whether the look was posted to the marketplace 204 for all users to see, or if the look was shared by another user), they are able to add the entire look 408 to their shopping cart 304, and buy the look 408 quickly and easily.

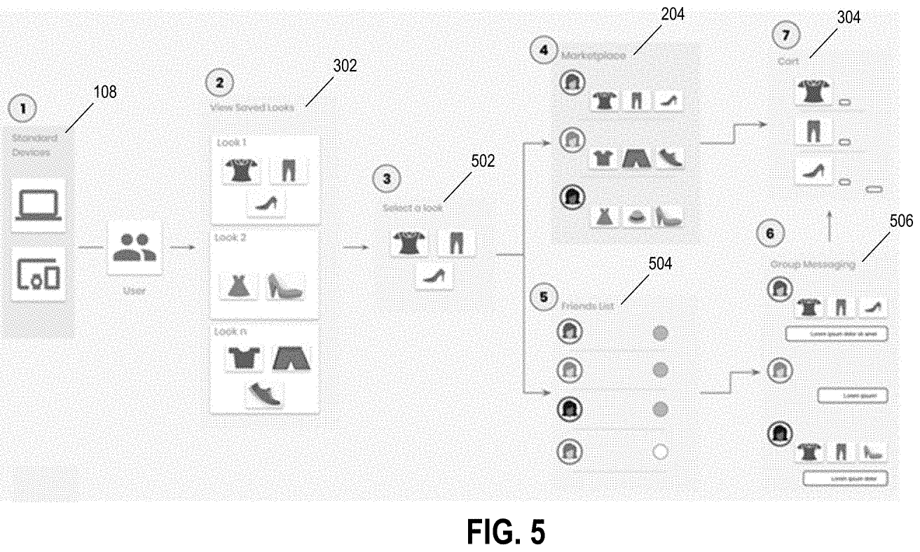

FIG. 5 is a diagram illustrating an example process for implementing a user flow of sharing, reacting, and buying a look on the architecture of FIG. 1. First, a user views marketplace 204 content via web browser or mobile application. Marketplace content is generated by the retailer, with user generated content created by influencers, designers, and shoppers (users). The user can navigate to view saved looks (look 1, look 2, . . . , look n), e.g., looks that the user has previously created and saved or looks that have been shared with the user by others in the marketplace 204 (other users, influencers, etc.). The user then selects a look 502 that they want to share, and is able to share it to the marketplace 204 or directly to other users 504 (one or multiple).

If the user decides to share the look 502 in the marketplace 204, the community of shoppers (users), influencers, designers will see it and be able to “quick react”, e.g., via emojis or likes, and comment on the look 502. If the user decides to share the look 502 directly to other users 504 (one or multiple), they will then select which users to share the look 502 with.

When the user shares a look with one or multiple users, the group 506 of users (sender and recipients of the look) are able to “quick react” to the look 502, add comments and respond to others in the chat experience about the look 502. Recipients of looks 502 are also able to modify the original look 502, that was received, as described in FIG. 4, by swapping out any of the items with other products from the marketplace 204 or their virtual closet 302. All users in the same group 506 chat are able to continue to “quick react” and comment on any of the looks received in the chat.

While any user is viewing any look (whether the look was posted to the marketplace 204 for all users to see, or if the look was shared by another user), they are able to add the entire look to their shopping cart, and buy the look quickly and easily.

It will be understood that the various layers can comprise one or more servers, processors, user interfaces, databases, etc., as needed to implement the system as described and perform the functions described herein.

FIG. 1 illustrates an example infrastructure in which one or more of the disclosed processes may be implemented, according to an embodiment. The infrastructure may comprise a platform 110 (e.g., one or more servers) which hosts and/or executes one or more of the various functions, processes, methods, and/or software modules described herein. Platform 110 may comprise dedicated servers, or may instead comprise cloud instances, which utilize shared resources of one or more servers. These servers or cloud instances may be collocated and/or geographically distributed. Platform 110 may also comprise or be communicatively connected to a server application 112 and/or one or more databases 114. In addition, platform 110 may be communicatively connected to one or more user systems 130 via one or more networks 120. Platform 110 may also be communicatively connected to one or more external systems 140 (e.g., other platforms, websites, etc.) via one or more networks 120.

Network(s) 120 may comprise the Internet, and platform 110 may communicate with user system(s) 130 through the Internet using standard transmission protocols, such as HyperText Transfer Protocol (HTTP), HTTP Secure (HTTPS), File Transfer Protocol (FTP), FTP Secure (FTPS), Secure Shell FTP (SFTP), and the like, as well as proprietary protocols. While platform 110 is illustrated as being connected to various systems through a single set of network(s) 120, it should be understood that platform 110 may be connected to the various systems via different sets of one or more networks. For example, platform 110 may be connected to a subset of user systems 130 and/or external systems 140 via the Internet, but may be connected to one or more other user systems 130 and/or external systems 140 via an intranet. Furthermore, while only a few user systems 130 and external systems 140, one server application 112, and one set of database(s) 114 are illustrated, it should be understood that the infrastructure may comprise any number of user systems, external systems, server applications, and databases.

User system(s) 130 may comprise any type or types of computing devices capable of wired and/or wireless communication, including without limitation, desktop computers, laptop computers, tablet computers, smart phones or other mobile phones, servers, game consoles, televisions, set-top boxes, electronic kiosks, point-of-sale terminals, Automated Teller Machines, and/or the like.

Platform 110 may comprise web servers which host one or more websites and/or web services. In embodiments in which a website is provided, the website may comprise a graphical user interface, including, for example, one or more screens (e.g., webpages) generated in HyperText Markup Language (HTML) or other language. Platform 110 transmits or serves one or more screens of the graphical user interface in response to requests from user system(s) 130. In some embodiments, these screens may be served in the form of a wizard, in which case two or more screens may be served in a sequential manner, and one or more of the sequential screens may depend on an interaction of the user or user system 130 with one or more preceding screens. The requests to platform 110 and the responses from platform 110, including the screens of the graphical user interface, may both be communicated through network(s) 120, which may include the Internet, using standard communication protocols (e.g., HTTP, HTTPS, etc.). These screens (e.g., webpages) may comprise a combination of content and elements, such as text, images, videos, animations, references (e.g., hyperlinks), frames, inputs (e.g., textboxes, text areas, checkboxes, radio buttons, drop-down menus, buttons, forms, etc.), scripts (e.g., JavaScript), and the like, including elements comprising or derived from data stored in one or more databases (e.g., database(s) 114) that are locally and/or remotely accessible to platform 110. Platform 110 may also respond to other requests from user system(s) 130.

Platform 110 may further comprise, be communicatively coupled with, or otherwise have access to one or more database(s) 114. For example, platform 110 may comprise one or more database servers which manage one or more databases 114. A user system 130 or server application 112 executing on platform 110 may submit data (e.g., user data, form data, etc.) to be stored in database(s) 114, and/or request access to data stored in database(s) 114. Any suitable database may be utilized, including without limitation MySQL™, Oracle™, IBM™, Microsoft SQL™, Access™, PostgreSQL™, and the like, including cloud-based databases and proprietary databases. Data may be sent to platform 110, for instance, using the well-known POST request supported by HTTP, via FTP, and/or the like. This data, as well as other requests, may be handled, for example, by server-side web technology, such as a servlet or other software module (e.g., comprised in server application 112), executed by platform 110.

In embodiments in which a web service is provided, platform 110 may receive requests from external system(s) 140, and provide responses in eXtensible Markup Language (XML), JavaScript Object Notation (JSON), and/or any other suitable or desired format. In such embodiments, platform 110 may provide an application programming interface (API) which defines the manner in which user system(s) 130 and/or external system(s) 140 may interact with the web service. Thus, user system(s) 130 and/or external system(s) 140 (which may themselves be servers), can define their own user interfaces, and rely on the web service to implement or otherwise provide the backend processes, methods, functionality, storage, and/or the like, described herein. For example, in such an embodiment, a client application 132 executing on one or more user system(s) 130 may interact with a server application 112 executing on platform 110 to execute one or more or a portion of one or more of the various functions, processes, methods, and/or software modules described herein. Client application 132 may be “thin,” in which case processing is primarily carried out server-side by server application 112 on platform 110. A basic example of a thin client application 132 is a browser application, which simply requests, receives, and renders webpages at user system(s) 130, while server application 112 on platform 110 is responsible for generating the webpages and managing database functions. Alternatively, the client application may be “thick,” in which case processing is primarily carried out client-side by user system(s) 130. It should be understood that client application 132 may perform an amount of processing, relative to server application 112 on platform 110, at any point along this spectrum between “thin” and “thick,” depending on the design goals of the particular implementation. In any case, the application described herein, which may wholly reside on either platform 110 (e.g., in which case server application 112 performs all processing) or user system(s) 130 (e.g., in which case client application 132 performs all processing) or be distributed between platform 110 and user system(s) 130 (e.g., in which case server application 112 and client application 132 both perform processing), can comprise one or more executable software modules that implement one or more of the processes, methods, or functions of the application described herein.

FIG. 7 is a block diagram illustrating an example wired or wireless system 550 that can be used in connection with various embodiments described herein. For example the system 550 can be used as or in conjunction with one or more of the systems, devices, engines or processes described above, and may represent components of a device, the corresponding backend server(s), and/or other layers or engines described herein. The system 550 can be a server or any conventional personal computer, or any other processor-enabled device that is capable of wired or wireless data communication. Other computer systems and/or architectures may be also used, as will be clear to those skilled in the art.

The system 550 preferably includes one or more processors, such as processor 560. Additional processors may be provided, such as an auxiliary processor to manage input/output, an auxiliary processor to perform floating point mathematical operations, a special-purpose microprocessor having an architecture suitable for fast execution of signal processing algorithms (e.g., digital signal processor), a slave processor subordinate to the main processing system (e.g., back-end processor), an additional microprocessor or controller for dual or multiple processor systems, or a coprocessor. Such auxiliary processors may be discrete processors or may be integrated with the processor 560. Examples of processors which may be used with system 550 include, without limitation, the Pentium® processor, Core i7® processor, and Xeon® processor, all of which are available from Intel Corporation of Santa Clara, Calif.

The processor 560 is preferably connected to a communication bus 555. The communication bus 555 may include a data channel for facilitating information transfer between storage and other peripheral components of the system 550. The communication bus 555 further may provide a set of signals used for communication with the processor 560, including a data bus, address bus, and control bus (not shown). The communication bus 555 may comprise any standard or non-standard bus architecture such as, for example, bus architectures compliant with industry standard architecture (ISA), extended industry standard architecture (EISA), Micro Channel Architecture (MCA), peripheral component interconnect (PCI) local bus, or standards promulgated by the Institute of Electrical and Electronics Engineers (IEEE) including IEEE 488 general-purpose interface bus (GPIB), IEEE 696/S-100, and the like.

System 550 preferably includes a main memory 565 and may also include a secondary memory 570. The main memory 565 provides storage of instructions and data for programs executing on the processor 560, such as one or more of the functions and/or modules discussed above. It should be understood that programs stored in the memory and executed by processor 560 may be written and/or compiled according to any suitable language, including without limitation C/C++, Java, JavaScript, Pearl, Visual Basic, .NET, and the like. The main memory 565 is typically semiconductor-based memory such as dynamic random access memory (DRAM) and/or static random access memory (SRAM). Other semiconductor-based memory types include, for example, synchronous dynamic random access memory (SDRAM), Rambus dynamic random access memory (RDRAM), ferroelectric random access memory (FRAM), and the like, including read only memory (ROM).

The secondary memory 570 may optionally include an internal memory 575 and/or a removable medium 580, for example a floppy disk drive, a magnetic tape drive, a compact disc (CD) drive, a digital versatile disc (DVD) drive, other optical drive, a flash memory drive, etc. The removable medium 580 is read from and/or written to in a well-known manner. Removable storage medium 580 may be, for example, a floppy disk, magnetic tape, CD, DVD, SD card, etc.

The removable storage medium 580 is a non-transitory computer-readable medium having stored thereon computer executable code (i.e., software) and/or data. The computer software or data stored on the removable storage medium 580 is read into the system 550 for execution by the processor 560.

In alternative embodiments, secondary memory 570 may include other similar means for allowing computer programs or other data or instructions to be loaded into the system 550. Such means may include, for example, an external storage medium 595 and an interface 590. Examples of external storage medium 595 may include an external hard disk drive or an external optical drive, or and external magneto-optical drive.

Other examples of secondary memory 570 may include semiconductor-based memory such as programmable read-only memory (PROM), erasable programmable read-only memory (EPROM), electrically erasable read-only memory (EEPROM), or flash memory (block oriented memory similar to EEPROM). Also included are any other removable storage media 580 and communication interface 590, which allow software and data to be transferred from an external medium 595 to the system 550.

System 550 may include a communication interface 590. The communication interface 590 allows software and data to be transferred between system 550 and external devices (e.g. printers), networks, or information sources. For example, computer software or executable code may be transferred to system 550 from a network server via communication interface 590. Examples of communication interface 590 include a built-in network adapter, network interface card (NIC), Personal Computer Memory Card International Association (PCMCIA) network card, card bus network adapter, wireless network adapter, Universal Serial Bus (USB) network adapter, modem, a network interface card (NIC), a wireless data card, a communications port, an infrared interface, an IEEE 1394 fire-wire, or any other device capable of interfacing system 550 with a network or another computing device.

Communication interface 590 preferably implements industry promulgated protocol standards, such as Ethernet IEEE 802 standards, Fiber Channel, digital subscriber line (DSL), asynchronous digital subscriber line (ADSL), frame relay, asynchronous transfer mode (ATM), integrated digital services network (ISDN), personal communications services (PCS), transmission control protocol/Internet protocol (TCP/IP), serial line Internet protocol/point to point protocol (SLIP/PPP), and so on, but may also implement customized or non-standard interface protocols as well.

Software and data transferred via communication interface 590 are generally in the form of electrical communication signals 605. These signals 605 are preferably provided to communication interface 590 via a communication channel 600. In one embodiment, the communication channel 600 may be a wired or wireless network, or any variety of other communication links. Communication channel 600 carries signals 605 and can be implemented using a variety of wired or wireless communication means including wire or cable, fiber optics, conventional phone line, cellular phone link, wireless data communication link, radio frequency (“RF”) link, or infrared link, just to name a few.

Computer executable code (i.e., computer programs or software) is stored in the main memory 565 and/or the secondary memory 570. Computer programs can also be received via communication interface 590 and stored in the main memory 565 and/or the secondary memory 570. Such computer programs, when executed, enable the system 550 to perform the various functions of the present invention as previously described.

In this description, the term “computer readable medium” is used to refer to any non-transitory computer readable storage media used to provide computer executable code (e.g., software and computer programs) to the system 550. Examples of these media include main memory 565, secondary memory 570 (including internal memory 575, removable medium 580, and external storage medium 595), and any peripheral device communicatively coupled with communication interface 590 (including a network information server or other network device). These non-transitory computer readable mediums are means for providing executable code, programming instructions, and software to the system 550.

In an embodiment that is implemented using software, the software may be stored on a computer readable medium and loaded into the system 550 by way of removable medium 580, I/O interface 585, or communication interface 590. In such an embodiment, the software is loaded into the system 550 in the form of electrical communication signals 605. The software, when executed by the processor 560, preferably causes the processor 560 to perform the inventive features and functions previously described herein.

In an embodiment, I/O interface 585 provides an interface between one or more components of system 550 and one or more input and/or output devices. Example input devices include, without limitation, keyboards, touch screens or other touch-sensitive devices, biometric sensing devices, computer mice, trackballs, pen-based pointing devices, and the like. Examples of output devices include, without limitation, cathode ray tubes (CRTs), plasma displays, light-emitting diode (LED) displays, liquid crystal displays (LCDs), printers, vacuum florescent displays (VFDs), surface-conduction electron-emitter displays (SEDs), field emission displays (FEDs), and the like.

The system 550 also includes optional wireless communication components that facilitate wireless communication over a voice and over a data network. The wireless communication components comprise an antenna system 610, a radio system 615 and a baseband system 620. In the system 550, radio frequency (RF) signals are transmitted and received over the air by the antenna system 610 under the management of the radio system 615.

In one embodiment, the antenna system 610 may comprise one or more antennae and one or more multiplexors (not shown) that perform a switching function to provide the antenna system 610 with transmit and receive signal paths. In the receive path, received RF signals can be coupled from a multiplexor to a low noise amplifier (not shown) that amplifies the received RF signal and sends the amplified signal to the radio system 615.

In alternative embodiments, the radio system 615 may comprise one or more radios that are configured to communicate over various frequencies. In one embodiment, the radio system 615 may combine a demodulator (not shown) and modulator (not shown) in one integrated circuit (IC). The demodulator and modulator can also be separate components. In the incoming path, the demodulator strips away the RF carrier signal leaving a baseband receive audio signal, which is sent from the radio system 615 to the baseband system 620.

If the received signal contains audio information, then baseband system 620 decodes the signal and converts it to an analog signal. Then the signal is amplified and sent to a speaker. The baseband system 620 also receives analog audio signals from a microphone. These analog audio signals are converted to digital signals and encoded by the baseband system 620. The baseband system 620 also codes the digital signals for transmission and generates a baseband transmit audio signal that is routed to the modulator portion of the radio system 615. The modulator mixes the baseband transmit audio signal with an RF carrier signal generating an RF transmit signal that is routed to the antenna system and may pass through a power amplifier (not shown). The power amplifier amplifies the RF transmit signal and routes it to the antenna system 610 where the signal is switched to the antenna port for transmission.

The baseband system 620 is also communicatively coupled with the processor 560. The central processing unit 560 has access to data storage areas 565 and 570. The central processing unit 560 is preferably configured to execute instructions (i.e., computer programs or software) that can be stored in the memory 565 or the secondary memory 570. Computer programs can also be received from the baseband processor 610 and stored in the data storage area 565 or in secondary memory 570, or executed upon receipt. Such computer programs, when executed, enable the system 550 to perform the various functions of the present invention as previously described. For example, data storage areas 565 may include various software modules (not shown).

Various embodiments may also be implemented primarily in hardware using, for example, components such as application specific integrated circuits (ASICs), or field programmable gate arrays (FPGAs). Implementation of a hardware state machine capable of performing the functions described herein will also be apparent to those skilled in the relevant art. Various embodiments may also be implemented using a combination of both hardware and software.

Furthermore, those of skill in the art will appreciate that the various illustrative logical blocks, modules, circuits, and method steps described in connection with the above described figures and the embodiments disclosed herein can often be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled persons can implement the described functionality in varying ways for each particular application, but such implementation decisions should not be interpreted as causing a departure from the scope of the invention. In addition, the grouping of functions within a module, block, circuit or step is for ease of description. Specific functions or steps can be moved from one module, block or circuit to another without departing from the invention.

Moreover, the various illustrative logical blocks, modules, functions, and methods described in connection with the embodiments disclosed herein can be implemented or performed with a general purpose processor, a digital signal processor (DSP), an ASIC, FPGA or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. A processor can also be implemented as a combination of computing devices, for example, a combination of a DSP and a microprocessor, a plurality of microprocessors, one or more microprocessors in conjunction with a DSP core, or any other such configuration.

Additionally, the steps of a method or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium including a network storage medium. An exemplary storage medium can be coupled to the processor such the processor can read information from, and write information to, the storage medium. In the alternative, the storage medium can be integral to the processor. The processor and the storage medium can also reside in an ASIC.

Any of the software components described herein may take a variety of forms. For example, a component may be a stand-alone software package, or it may be a software package incorporated as a “tool” in a larger software product. It may be downloadable from a network, for example, a website, as a stand-alone product or as an add-in package for installation in an existing software application. It may also be available as a client-server software application, as a web-enabled software application, and/or as a mobile application.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed:

1. A system comprising:
a plurality of user devices comprising an application or web browser;
one or more databases configured to store customer data, product data, and look data;
an orchestration server coupled with the one or more databases and the user devices, coupled with the one or more databases and the user devices, and comprising at least one hardware processor; and one or more software modules that are configured to, when executed by the at least one hardware processor:
present a marketplace comprising items associated with the product information and to allow a user of one of the plurality of user devices to create a look using the application or browser by:
selecting one or multiple products from the marketplace to form a look;
edit the look by adding or deleting products;
sharing the look with other users of the plurality of user devices;
receive quick reactions to the shared look from the other users; and
edit the look again based on the quick reactions.

2. The system of claim 1, wherein the one or more software modules that are further configured to, when executed by the at least one hardware processor: save the look and view previously created looks in a profile via a virtual closet.

3. The system of claim 1, wherein the one or more software modules that are further configured to, when executed by the at least one hardware processor: allow the user to add the look to a shopping cart; and buy purchase the look with one click.

4. The system of claim 1, wherein the one or more software modules that are further configured to, when executed by the at least one hardware processor: allow the user to share the look they created with a select group of users, or via the marketplace.

5. The system of claim 1, wherein the one or more software modules that are further configured to, when executed by the at least one hardware processor: allow the user to receive looks shared by other users, modify the received looks, store the received looks in the virtual closet, and purchase the received looks via one click.
